(19) United States
(12) Patent Application Publication
(10) Pub. No.: US 2023/0085781 A1
(43) Pub. Date: Mar. 23, 2023

(54) AIRCRAFT GROUND GUIDANCE SYSTEM AND METHOD BASED ON SEMANTIC RECOGNITION OF CONTROLLER INSTRUCTION

(71) Applicants: CIVIL AVIATION UNIVERSITY OF CHINA, Tianjin (CN); THE SECOND RESEARCH INSTITUTE OF CAAC, Chengdu City (CN)

(72) Inventors: Jingchang ZHUGE, Tianjin (CN); Qian LUO, Tianjin (CN); Ye PAN, Tianjin (CN); Chang LIU, Tianjin (CN); Yi YOU, Tianjin (CN); Zhiwei XING, Tianjin (CN)

(73) Assignees: CIVIL AVIATION UNIVERSITY OF CHINA, Tianjin (CN); THE SECOND RESEARCH INSTITUTE OF CAAC, Chengdu City (CN)

(21) Appl. No.: 18/059,967

(22) Filed: Nov. 29, 2022

Related U.S. Application Data
(63) Continuation of application No. PCT/CN2021/098174, filed on Jun. 3, 2021.

(30) Foreign Application Priority Data
Jun. 8, 2020 (CN) 202010511326.6

(51) Int. Cl. G08G 5/00; G08G 5/06; G10L 15/18; G10L 15/16; G10L 15/06; G06F 16/29; G06T 19/00

(52) U.S. Cl. CPC G08G 5/0021; G08G 5/065; G10L 15/1815; G10L 15/16; G10L 15/063; G06F 16/29; G06T 19/006

(57) ABSTRACT

Disclosed are an aircraft ground guidance system and method based on semantic recognition of a controller instruction. The system includes a semantic recognition module, a path generation and geographic information system (GIS) mapping module, and an aircraft guidance terminal module. The system can improve safety of aircraft ground operation, does not require manual operation of an aircraft guidance vehicle, can reduce construction, transformation, maintenance and operation costs, and meets airport control requirements, and a highly reliable, low-fault, economical and practical airport control decision support system and aircraft ground guidance system in an airport flight area are formed, improving the safety of aircraft ground operation.

### CROSS REFERENCE TO RELATED APPLICATION

This application is a Continuation of International Application No. PCT/CN2021/098174, filed Jun. 3, 2021, which claims the benefit and priority of Chinese Patent Application No. 202010511326.6, filed Jun. 8, 2020; the disclosures of all of which are incorporated herein by reference in their entirety.

### TECHNICAL FIELD

The present disclosure relates to the technical field of airport management, and in particular, to an aircraft ground guidance system and method based on semantic recognition of a controller instruction.

### BACKGROUND

Currently, global civil aviation industry has entered a high-speed development stage. In the past 20 years, the quantity of flights in the busiest international airports has doubled, but the quantity of airport pavements and taxiways has not increased correspondingly. Therefore, large airports, especially hub airports, in various countries are in a high-load operation state in the long run. This will lead to many problems in airport operation, especially increasing the pressure of airports in term of aircraft taxiing guidance on the ground. When an aircraft is traveling in a taxiing area or on a pavement of an airport, an aircraft guidance vehicle or an advanced surface movement guidance control system is generally used to guide the aircraft on the ground. The former method is to guide, by using the aircraft guidance vehicle, the aircraft in taxiing on the airport ground before the aircraft takes off or after the aircraft lands, and it is stipulated that a distance between the guidance vehicle and the aircraft should not exceed 50 meters. In the latter method, the advanced surface movement guidance control system is a comprehensive integrated system that can implement control of aircraft on the surface through monitoring, route planning and guidance functions. However, the disadvantage of these two methods is that the investment of manpower and material resources is large. The former method may be greatly affected by human factors and weather factors; the latter method requires an excessively large capital investment during construction or renovation, and requires renovation of navigational lights especially in an existing airport, leading to relatively high construction difficulty. Therefore, these two guidance methods have the disadvantages of poor practicality and economy. In addition, the busier the airport is, the greater the requirements for controllers and aircraft scheduling are, so controllers and special vehicle drivers are getting increasingly busier, which correspondingly increases an error rate of controllers and related scheduling personnel.

### SUMMARY

In order to solve the foregoing problems, an object of the present disclosure is to provide an aircraft ground guidance system and method based on semantic recognition of a controller instruction.

To achieve the foregoing object, an aircraft ground guidance system based on semantic recognition of a controller instruction according to the present disclosure includes a semantic recognition module, a path generation and geographic information system (GIS) mapping module, and an aircraft guidance terminal module, where the semantic recognition module is configured to acquire a controller instruction from an airport control seat and pilot speech and extract element information; the path generation and GIS mapping module converts the controller instruction into an aircraft taxiing path based on a result of the semantic recognition, maps the aircraft taxiing path to an airport GIS, verifies security of the controller instruction, and then generates an aircraft taxiing path map related to aircraft operation on the ground; and the aircraft guidance terminal module displays a real-time position of an aircraft and an established taxiing path map to a pilot, and provides augmented reality (AR) aircraft guidance based on a real scene of an airport flight area pavement.

An aircraft ground guidance method based on semantic recognition of a controller instruction according to the present disclosure includes following steps that are sequentially performed:

(1) constructing a controller-specific speech database that is used for safe operation of an airport:

acquiring, based on an airport control workflow, a flight area-related operation management standard, information content of a controller instruction, and a controller's standard phrasebook Radiotelephony Communications for Air Traffic Services, speech data and a pronunciation text in three ways of: backing up a land-air communication record between a controller in an airport and a pilot, using a very high frequency (VHF) communication device or a tower speech access device to acquire information about a speech conversation between the controller and the pilot, and using a speech file of Radiotelephony Communications for Air Traffic Services; segmenting the pronunciation text of the controller and the pilot, marking the speech data with segments and prosody, to form a data set composed of marked speech files that conform to norms of airport control standard phrases, and finally constructing the controller-specific speech database that is used for safe operation of an airport;

(2) acquiring, by a semantic recognition module, the speech conversation between the controller and the pilot based on the controller-specific speech database:

separately acquiring, based on the controller-specific speech database, controller instructions of seats including a release seat, a ground seat and a tower seat, and pilot speech, and training the speech based on an intelligent learning method, to accurately recognize speech of special terms from different seats;

(3) performing noise processing and speech recognition on the acquired speech conversation:

filtering out VHF communication noise and high background noise of the airport in the acquired speech conversation, and incorporating an amplifier to increase a signal-to-noise ratio; where the method is to extract a frequency spectrum of the noise, and perform a reverse compensation operation for the speech with noise based on the frequency spectrum of the noise, so as to obtain a denoised speech conversation; and

performing speech recognition on the denoised speech conversation, and obtaining a recognized text;

(4) performing semantic recognition on the speech conversation after the speech recognition:

extracting, from the controller instruction, element information including a flight number, push-out information, path information, a key position point, a starting point, and a time sequence based on the speech recognition of the controller and the pilot, associatively analyze a plurality of elements, and performing, by using technical means such as word parsing, information extraction, time causality and emotion judgment and in combination with a configuration of an airport flight area, semantic recognition for a plurality of times on the speech conversation after the speech recognition to obtain semantic recognition information, so as to provide guarantee for aircraft taxiing guidance on the ground;

(5) verifying, by a path generation and GIS mapping module, security of the controller instruction based on the semantic recognition information, and generating an aircraft taxiing path map:

mapping the semantic recognition information to an airport GIS, performing simulation deduction of a path and process of aircraft taxiing on the airport ground based on the controller instruction, receiving aircraft taxiing path information based on the semantic recognition of the controller instruction, verifying security of the controller instruction, feeding the information back to the controller with a probability of occurrence of an aircraft conflict event, and generating an aircraft taxiing path map related to aircraft ground operation;

(6) combining, by an aircraft guidance terminal module, a global positioning system (GPS), an airport base station and information of a marker at a specific position of the airport flight area to obtain a real-time position of the aircraft:

combining, by the aircraft guidance terminal module, base station positioning, the GPS and the information of the marker at the specific position of the airport flight area, to further improve positioning precision and meet a requirement of real-time positioning;

(7) acquiring a front-end perspective image of the aircraft in real time, and recognizing the marker at the specific position of the airport flight area:

acquiring the front-end perspective image of the aircraft in real time, and recognizing the marker at the specific position of the airport flight area; wherein when the front-end perspective image of the aircraft successfully is matched with a template in the aircraft guidance terminal module, a distance between the aircraft and the marker at the specific position of the airport flight area is calculated based on a transformation matrix between the template and the front-end perspective image of the aircraft, to assist in aircraft positioning, and forming a virtual image that carries aircraft ground guidance information; and

(8) performing AR navigation based on the acquired real-time position of the aircraft and the recognition of the marker at the specific position of the airport flight area:

receiving the front-end perspective image of the aircraft acquired in real time while forming the virtual image; rendering the virtual image, and displaying in an enhanced manner on the front-end perspective image of the aircraft acquired in real time, to form a real image of AR; superposing the front-end perspective image of the aircraft acquired in real time to the virtual image that carries the aircraft ground guidance information, to form an aircraft ground guidance display image for the pilot to observe, so as to achieve an object of navigating in a real scene of an airport flight area pavement; and finally displaying the real-time position of the aircraft and the aircraft taxiing path map to the pilot in an aircraft cockpit, and providing a speech prompt to perform aircraft taxiing guidance on the ground in a more visual manner.

The semantic recognition module performs following operation steps:

preprocessing a denoised speech conversation signal, extracting feature parameters from the speech conversation signal based on the neural network, training and recognizing an acoustic model, a language model, and a dictionary by using the feature parameters, comparing the feature parameters with the trained acoustic model, language model, and dictionary, calculating a corresponding probability by using rules, and selecting a result that matches a maximum probability of the feature parameters, to obtain text after speech recognition; extracting, from the text after speech recognition, element information including a flight number, push-out information, path information, a key position point, a starting point, and a time sequence, associatively analyzing a plurality of elements, and performing, by using technical means comprising word parsing, information extraction, time causality and emotion judgment and in combination with a configuration of an airport flight area, semantic recognition for a plurality of times on the speech conversation after the speech recognition to obtain semantic recognition information, so as to provide guarantee for aircraft taxiing guidance on the ground.

The training refers to acquiring model parameters, evaluating an ability of a speech recognition model in recognizing airport control standard phrases, matching with the controller-specific speech database, and optimizing an ability in fitting and generalizing the airport control standard phrases;

the recognition is a process of traversing the controller-specific speech database;

the acoustic model represents pronunciation of a language built based on the neural network, and is capable of recognizing a controller speech model and features of a tower environment;

the language model is a probability model that regularizes words of the controller-specific speech database; and

the dictionary contains a large number of unique professional terms and pronunciation rules in field of a civil aviation control.

Compared with an existing method, the present disclosure has the following advantages:

1. In the present disclosure, in view of hidden dangers of human factors—“mistakes, forgetfulness, and missing” of controllers and related scheduling personnel in an air traffic control process, the security of controller instructions is verified, accidents and accident symptoms caused by human factors in a control and dispatching process can be effectively eliminated, and safety of aircraft a ground operation is greatly improved.

2. The guidance system does not require manual operation of an aircraft guidance vehicle, and there is no situation that the aircraft is guided to be parked at a wrong position or guidance is missed due to human factors. The guidance system does not need to be guided by means of navigational lights, and will not be affected by failure of the navigation lights. In the present disclosure, large-scale reconstruction of an existing airport flight area, especially a pavement, is not required, and aircraft guidance vehicles and navigational lights are not involved, which can greatly reduce construction costs, reconstruction costs, maintenance costs, and operation costs.

3. In the present disclosure, precision of an aircraft navigation system is ensured through a combination of a GPS, an airport base station and recognition of a marker at a specific position of an airport flight area and by using an aircraft ground taxiing path generated by an airport GIS. A real-time position of an aircraft and an established taxiing path are displayed to a pilot by a display terminal, and AR aircraft guidance based on a real scene of an airport flight area pavement is provided, which ensures practicability of the system and improves efficiency of aircraft guidance.

4. The present disclosure meets airport control requirements, and a highly reliable, low-fault, economical and practical airport control decision support system and aircraft ground guidance system in an airport flight area are formed, improving the safety of aircraft ground operation.

### BRIEF DESCRIPTION OF THE DRAWINGS

FIG. 1 is a flowchart of an aircraft ground guidance method based on semantic recognition of a controller instruction according to the present disclosure.

### DETAILED DESCRIPTION

The various modules, systems and embodiments noted herein can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

The present disclosure is further described in detail below.

An aircraft ground guidance system based on semantic recognition of a controller instruction according to the present disclosure includes a semantic recognition module, a path generation and GIS mapping module, and an aircraft guidance terminal module. The semantic recognition module is configured to acquire a controller instruction from an airport control seat and pilot speech and extract element information. The path generation and GIS mapping module converts the controller instruction into an aircraft taxiing path based on a result of the semantic recognition, maps the aircraft taxiing path to an airport GIS, verifies security of the controller instruction, and then generates an aircraft taxiing path map related to aircraft ground operation. Further, the aircraft guidance terminal module displays a real-time position of an aircraft and an established taxiing path map to the pilot, and provides AR aircraft guidance based on a real scene of an airport flight area pavement.

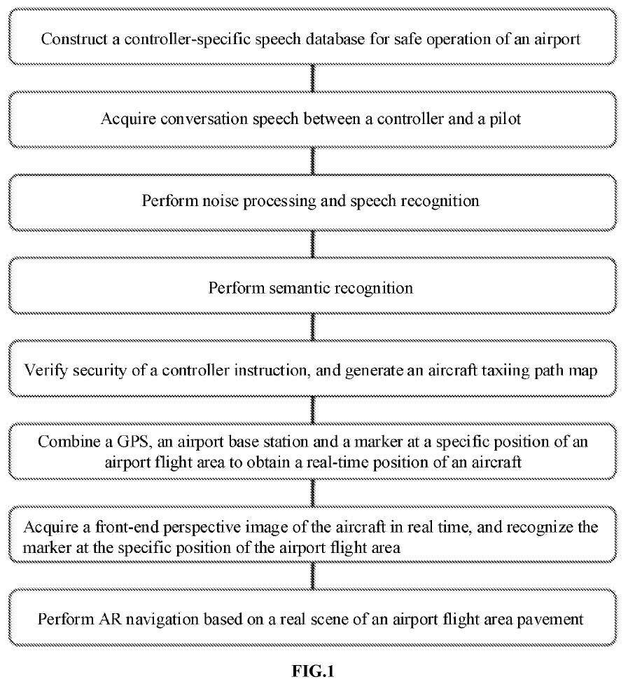

As shown in FIG. 1, an aircraft ground guidance method using the foregoing aircraft ground guidance system based on semantic recognition of a controller instruction according to the present disclosure includes the following steps (1) to (8) that are sequentially performed.

In step (1), a controller-specific speech database is constructed for airport safe operation.

Specifically, the purpose of constructing the controller-specific speech database for airport safe operation is to fully reflect unique acoustic characteristics in field of a civil aviation control and provide a complete data set for establishing a speech model. Based on an airport control workflow, a flight area-related operation management standard, information content of a controller instruction, and a controller's standard phrasebook Radiotelephony Communications for Air Traffic Services, speech data and a pronunciation text are acquired in three ways of: backing up a ground-air communication record between a controller in an airport and a pilot, using a VHF communication device or a tower speech access device to acquire information about a speech conversation between the controller and the pilot, and using a speech file of Radiotelephony Communications for Air Traffic Services. The pronunciation text of the controller and the pilot are segmented, the speech data are marked with segments and prosody, to form a data set composed of marked speech files that conform to airport control standard phrases, and finally a controller-specific speech database for airport safe operation is constructed.

In step (2), the speech conversation between the controller and the pilot are acquired by a semantic recognition module based on the controller-specific speech database.

Based on the controller-specific speech database for airport safe operation, which is constructed with speech conversation information between the controller and the pilot in Radiotelephony Communications for Air Traffic Services as basic morphemes, controller instructions of seats including a release seat, a ground seat and a tower seat, and pilot speech are separately acquired, and then the foregoing speech are trained based on an intelligent learning method to accurately recognize special terms speech of different seats.

In step (3), noise processing and speech recognition are performed on the acquired speech conversation.

Because speech acquired at the airport is usually mixed with background sound with a certain intensity, which is usually VHF communication noise and high airport background noise, and when the background noise has a relatively high intensity, it will have a significant impact on a subsequent speech recognition effect. Therefore, VHF communication noise and high background noise of the airport in the acquired speech conversation are filtered out, so as to reduce noise interference, and an amplifier is incorporated to increase a signal-to-noise ratio. The method is to extract a frequency spectrum of the noise, and then perform a reverse compensation operation on the speech with noise based on the frequency spectrum of the noise, so as to obtain a denoised speech conversation.

Then speech recognition is performed on the denoised speech conversation, and a recognized text is obtained. The semantic recognition module performs the following specific operation steps.

Firstly, a denoised speech conversation signal is preprocessed, feature parameters are extracted from the speech conversation signal based on the neural network. Then, an acoustic model, a language model, and a dictionary are trained and recognized by using the feature parameters. Finally, the feature parameters are compared with the trained acoustic model, language model, and dictionary, a corresponding probability is calculated by using rules, and a result that matches with a maximum probability of the feature parameters is selected, so as to obtain text for the speech recognition.

The training refers to acquiring model parameters, evaluating the ability of a semantic recognition model in recognizing airport control standard phrases, matching with the controller-specific speech database, and optimizing the ability in fitting and generalizing the airport control standard phrases.

The recognition is a process of traversing the controller-specific speech database.

The acoustic model represents pronunciation of a language built based on the neural network, and can be trained to recognize a controller speech model and features of a tower environment.

The language model is a probability model that regularizes words in the controller-specific speech database.

The dictionary contains a large number of unique professional terms and pronunciation rules in the field of civil aviation control.

In step (4), semantic recognition is performed on the speech conversation after the speech recognition.

From the controller instruction, element information including a flight number, push-out information, path information, a key position point, a starting point, and a time sequence is extracted based on the speech recognition of the controller and the pilot, a plurality of elements are associatively analyzed, and by using technical means such as word parsing, information extraction, time causality and emotion judgment and in combination a configuration of an airport flight area, semantic recognition is performed on the speech conversation after the speech recognition to obtain semantic recognition information, so as to ensure aircraft taxiing guidance on the ground. To improve accuracy of the semantic recognition, it is required to perform semantic recognition for a plurality of times on the speech conversation after the speech recognition and to acquire a large amount of speech data, and the model in the semantic recognition module is continuously trained by using the data.

In step (5), by a path generation and GIS mapping module, security of the controller instruction is verified based on the semantic recognition information, and an aircraft ground taxiing path map is generated.

Specifically, the semantic recognition information is mapped to an airport GIS, a path and process of aircraft taxiing on the airport ground based on the controller instruction is simulated, aircraft taxiing path information based on the semantic recognition of the controller instruction is received, security of the controller instruction is verified, and the information back is fed to the controller in a form of a probability of occurrence of an aircraft conflict event, and generate an aircraft taxiing path map related to aircraft ground operation.

In step (6), by an aircraft guidance terminal module, a GPS, an airport base station and information of a marker at a specific position of the airport flight area combined to obtain a real-time position of the aircraft.

Due to relatively strong dependence of the GPS on satellites, there are many blind spots. In a base station positioning method, data can be directly collected by a base station, and there is no blind spot in a coverage area of a network. Therefore, base station positioning, the GPS and the information of the marker at the specific position of the airport flight area are combined together by the aircraft guidance terminal module, which can further improve positioning precision and meet a requirement of real-time positioning.

In step (7), a front-end perspective image of the aircraft is acquired in real time, and the marker at the specific position of the airport flight area is recognized.

Specifically, the front-end perspective image of the aircraft is acquired in real time, and the marker at the specific position of the airport flight area is recognized. When the front-end perspective image of the aircraft is successfully matched with a template in the aircraft guidance terminal module, a distance between the aircraft and the marker at the specific position of the airport flight area is calculated based on a transformation matrix between the template and the front-end perspective image of the aircraft, to assist in aircraft positioning and forming a virtual image that carries aircraft ground guidance information.

In step (8), AR navigation is performed based on the acquired real-time position of the aircraft and the recognition of the marker at the specific position of the airport flight area.

Specifically, the front-end perspective image of the aircraft acquired in real time is received, while the virtual image is formed. The virtual image is rendered, and displayed, in an enhanced manner, on the front-end perspective image of the aircraft acquired in real time, to form a real image of AR. By superposing the front-end perspective image of the aircraft acquired in real time to the virtual image that carries the aircraft ground guidance information, an aircraft ground guidance display image is formed for the pilot to observe, so as to achieve an object of navigating in a real scene of an airport flight area pavement. Finally, the real-time position of the aircraft and the aircraft taxiing path map are displayed to the pilot in an aircraft cockpit, and a speech prompt is provided to perform aircraft ground taxiing guidance in a more visual manner.

In the present disclosure, in view of special pronunciation of air traffic control, a special speech database that conforms to airport control standard phrases is constructed, to implement speech recognition of special terms for controllers. Based on the speech recognition, element information such as a flight number, push-out information, path information, a key position point, a starting point and a time sequence is extracted from a controller instruction, a plurality of elements is analyzed associatively, and semantic recognition is performed in combination a configuration of an airport flight area. An aircraft taxiing path is mapped to an airport GIS, to generate an aircraft ground taxiing path map related to aircraft operation on the ground. A real-time position of an aircraft and an established aircraft taxiing path map are displayed to a pilot by a display terminal, and a speech prompt is provided, to perform AR navigation based on a real scene of an airport flight area pavement.

The content not described in detail in the description of the present disclosure is prior art known by those skilled in the art.

What is claimed is:

1. An aircraft ground guidance system based on semantic recognition of a controller instruction, comprising:
a semantic recognition module;
a path generation and geographic information system (GIS) mapping module; and
an aircraft guidance terminal module,
wherein the semantic recognition module is configured to acquire the controller instruction from an airport control seat and pilot speech and extract element information;
the path generation and GIS mapping module converts the controller instruction into an aircraft taxiing path based on a result of the semantic recognition, maps the aircraft taxiing path to an airport GIS, performs security verification of the controller instruction, and generates an aircraft taxiing path map related to aircraft operation on the ground; and
the aircraft guidance terminal module displays a real-time position of an aircraft and an established taxiing path map to a pilot, and provides augmented reality (AR) aircraft guidance based on a real scene of an airport flight area pavement.

2. The aircraft ground guidance method using the aircraft ground guidance system based on semantic recognition of a controller instruction according to claim 1, wherein the aircraft ground guidance method comprises the following steps that are sequentially performed:
(1) constructing a controller-specific speech database for safe operation of an airport:
acquiring, based on an airport control workflow, a flight area-related operation management standard, information content of a controller instruction, and a controller's standard phrasebook, speech data and a pronunciation text in three ways of: backing up a ground-air communication record between a controller in an airport and a pilot, using a very high frequency (VHF) communication device or a tower speech access device to acquire information about a speech conversation between the controller and the pilot, and using a speech file of the controller's standard phrasebook; segmenting the pronunciation text of the controller and the pilot, marking the speech data with segments and prosody, to form a data set composed of marked speech files that conform to airport control standard phrases, and finally constructing the controller-specific speech database for safe operation of an airport;
(2) acquiring, by the semantic recognition module, the speech conversation between the controller and the pilot based on the controller-specific speech database:
separately acquiring, based on the controller-specific speech database, controller instructions of seats comprising a release seat, a ground seat and a tower seat, and pilot speech, and training the speech based on an intelligent learning method, to accurately recognize speech of special terms from different seats;
(3) performing noise processing and speech recognition on the acquired speech conversation:
filtering out VHF communication noise and high background noise of the airport in the acquired speech conversation, and incorporating an amplifier to increase a signal-to-noise ratio; wherein the method is to extract a frequency spectrum of the noise, and perform a reverse compensation operation for the speech with noise based on the frequency spectrum of the noise, so as to obtain a denoised speech conversation; and
performing speech recognition on the denoised speech conversation, and obtaining a recognized text;
(4) performing semantic recognition on the speech conversation after the speech recognition:
extracting, from the controller instruction, element information comprising a flight number, push-out information, path information, a key position point, a starting point, and a time sequence based on the speech recognition of the controller and the pilot, associatively analyze a plurality of elements, and performing, by using technical means such as word parsing, information extraction, time causality and emotion judgment and in combination with a configuration of an airport flight area, semantic recognition for a plurality of times on the speech conversation after the speech recognition to obtain semantic recognition information, so as to provide guarantee for aircraft taxiing guidance on the ground;
(5) verifying, by a path generation and GIS mapping module, security of the controller instruction based on the semantic recognition information, and generating an aircraft ground taxiing path map:
mapping the semantic recognition information to an airport GIS, performing simulation deduction of a path and process of aircraft taxiing on the airport ground based on the controller instruction, receiving aircraft taxiing path information based on the semantic recognition of the controller instruction, verifying security of the controller instruction, feeding the information back to the controller with a probability of occurrence of an aircraft conflict event, and generating an aircraft taxiing path map related to aircraft ground operation;
(6) combining, by an aircraft guidance terminal module, a global positioning system (GPS), an airport base station and information of a marker at a specific position of the airport flight area to obtain a real-time position of the aircraft:
combining, by the aircraft guidance terminal module, base station positioning, the GPS and the information of the marker at the specific position of the airport flight area, to further improve positioning precision and meet a requirement of real-time positioning;
(7) acquiring a front-end perspective image of the aircraft in real time, and recognizing the marker at the specific position of the airport flight area:
acquiring the front-end perspective image of the aircraft in real time, and recognizing the marker at the specific position of the airport flight area; wherein when the front-end perspective image of the aircraft is successfully matched with a template in the aircraft guidance terminal module, a distance between the aircraft and the marker at the specific position of the airport flight area is calculated based on a transformation matrix between the template and the front-end perspective image of the aircraft, to assist in aircraft positioning, and forming a virtual image that carries aircraft ground guidance information; and
(8) performing AR navigation based on the acquired real-time position of the aircraft and the recognition of the marker at the specific position of the airport flight area:
receiving the front-end perspective image of the aircraft acquired in real time while forming the virtual image; rendering the virtual image, and displaying in an enhanced manner on the front-end perspective image of the aircraft acquired in real time, to form a real image of AR; superposing the front-end perspective image of the aircraft acquired in real time to the virtual image that carries the aircraft ground guidance information, to form an aircraft ground guidance display image for the pilot to observe, so as to achieve an object of navigating in a real scene of an airport flight area pavement; and finally displaying the real-time position of the aircraft and the aircraft taxiing path map to the pilot in an aircraft cockpit, and providing a speech prompt to perform aircraft taxiing guidance on the ground in a more visual manner.

3. The aircraft ground guidance method according to claim 2, wherein in step (3), the semantic recognition module performs following operation steps:
preprocessing a denoised speech conversation signal, extracting feature parameters from the denoised speech conversation signal based on the neural network, training and recognizing an acoustic model, a language model, and a dictionary by using the feature parameters, comparing the feature parameters with the trained acoustic model, language model, and dictionary, calculating a corresponding probability by using rules, and selecting a result that matches with a maximum probability of the feature parameters, to obtain text after speech recognition; extracting, from the text after speech recognition, element information comprising a flight number, push-out information, path information, a key position point, a starting point, and a time sequence, associatively analyzing a plurality of elements, and performing, by using technical means comprising word parsing, information extraction, time causality and emotion judgment and in combination with a configuration of an airport flight area, semantic recognition for a plurality of times on the speech conversation after the speech recognition to obtain semantic recognition information, so as to provide guarantee for aircraft taxiing guidance on the ground.

4. The aircraft ground guidance method according to claim 3, wherein the training refers to acquiring model parameters, evaluating an ability of a speech recognition model in recognizing airport control standard phrases, matching with the controller-specific speech database, and optimizing an ability in fitting and generalizing the airport control standard phrases;
the recognition is a process of traversing the controller-specific speech database;
the acoustic model represents pronunciation of a language built based on the neural network, and is capable of recognizing a controller speech model and features of a tower environment through training;
the language model is a probability model that regularizes words of the controller-specific speech database; and
the dictionary contains many unique professional terms and pronunciation rules in field of a civil aviation control.
